(19) United States
(12) Patent Application Publication
(10) Pub. No.: US 2003/0218040 A1
(43) Pub. Date: Nov. 27, 2003

(54) Method for storing and dispensing wet wipes

(75) Inventors: Michael John Faulks, Neenah, WI (US); Kim G. Schick, Menasha, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/154,632

(22) Filed: May 23, 2002

(51) Int. Cl. B26F 3/00

(52) U.S. Cl. 225/1; 225/106

(57) ABSTRACT

There is provided a method for storing and dispensing wet wipes, comprising: providing a dispenser and a plurality of releasably connected wet wipes; positioning a leading wet wipe of the plurality of releasably connected wet wipes in a dispensing opening in communication with the chamber, dispensing the plurality of releasably connected wet wipes in a direction away from the dispensing opening; and manually separating the leading wet wipe from an immediately trailing wet wipe, by various ways, while also maintaining a portion of each of the leading wet wipe and the trailing wet wipe in the dispensing opening.

### BACKGROUND OF THE INVENTION

Products, such as wet wipes, have many applications. They may be used with small children and infants when changing diapers, they may be used for household cleaning tasks, they may be used for cleaning hands or face, they may be used as a bath tissue, they may be used by a caregiver to clean a disabled or incontinent adult, or they may be used in and for a whole host of other applications, where it is advantageous to have a wipe or towel that has some moisture in it.

Wet wipes have been traditionally dispensed in sheet form from a tub like container with a hinged lid on the top. The lid is opened and individual or singularized sheets of the wipes are removed. Another type of container that has been used for wet wipes provides a roll of wipes in which the wipes are pulled from the top of the container in a direction that is parallel to the axis of the roll. These wipes are pulled from the center of a hollow coreless roll that has perforated sheets. These containers generally have a snap top lid that is opened to expose a piece of the wipes that can then be pulled to remove the desired amount of wipes. Once pulled out the wipes can then be torn off, usually at a perforation, and the lid closed. Still another type of container that has been used for wet wipes provides a roll of wipes in which the wipes are pulled from the side or top of the container in a direction that is perpendicular to the axis of the roll. These wipes are pulled from the outer periphery of a roll that has perforated sheets. These containers can have a clam shell configuration (e.g., like those seen in U.S. Pat. No. 5,897,074 issued Apr. 27, 1999, and which is incorporated herein by reference) that is opened to expose a piece of the wipes that can then be pulled to remove the desired amount of wipes through an opening once the clam shell is closed and the wipes threaded through the opening.

Wet wipes can be any wipe, towel, tissue or sheet like product including natural fibers, synthetic fibers, synthetic material and combinations thereof, that is wet or moist or becomes wet during use or prior to use. Examples of wet wipes are disclosed in U.S. application Ser. Nos.: 09/900,698 filed Jul., 6, 2001; 09/871,019 filed May 31, 2001; 09/564,449, 09/564,939, 09/564,531, 09/564,268, 09/564,424, and 09/565,623 all filed May 4, 2000; and 09/223,999 filed Dec. 31, 1998, all commonly owned by the assignee of this application and the disclosures of which are incorporated herein by reference. Embodiments of wet wipes dispensers are described in U.S. application Ser. Nos.: 09/565,227 filed May 4, 2000; 09/545,995 filed Apr. 10, 2000; 09/659,307; 09/659,295, 09/660,049, 09/659,311, 09/660,040, 09/659,283, 09/659,284, and 09/659,306 filed Sep. 12, 2000; 09/748,618, filed Dec. 22, 2000; 09/841,323, filed Apr. 24, 2001; 09/849,935 filed May 4, 2001; 09/900,359 filed Jul. 6, 2001; 09/916,825, filed Jul. 27, 2001; and 10/016,952, filed Dec. 14, 2001; all commonly owned by the assignee of this application and the disclosures of which are incorporated herein by reference.

The dispensing of products or wet wipes from such conventional dispensers has not been completely satisfactory. For example, this is due at least in part to the nature of a wipe being wet and the desire to preserve the moisture imparted to the sheet to keep it wet at its original liquid add on level for a longer period of time. In particular, for example, this can also concern the configuration and characteristics of the dispenser with wet wipes therein. As another example, this can concern the configuration and characteristics of the wet wipes (e.g., in roll or stack forms) that have individual wipes releasably connected to each adjacent wipe to provide continuous dispensing once an initial wipe is dispensed through the dispensing opening. Still further, this can concern a need or desire to reduce contamination of the product or wipe from a surrounding environment.

### SUMMARY OF THE INVENTION

In response to the difficulties and shortcomings discussed above, for example, a new storing and dispensing method enabling improved dispensing, and which may be more desirable and reliable (e.g., reducing wet wipe dry out and/or reducing the likelihood of wipe fallback and/or reducing contamination), has been developed. For example, dispensing can be improved or made easier when a product or wipe is ready for dispensing each time it is wanted after the initial opening of the dispenser and use of a first wipe in a group of wipes (e.g., in roll or stack forms). That is, a select portion of the product or wipe is more reliably positioned in the dispensing opening of the dispenser sufficiently protruding so a user can readily grasp the same and remove the entire individual product or wipe without premature tearing or non-dispensing of the leading product or wipe. As another example, product or wipe fallback can occur when a leading product or wipe in the group separates completely from a following or trailing product or wipe prematurely, i.e., before a sufficient portion of the following product or wipe is positioned in the dispensing opening to remain there for later dispensing after the leading product or wipe is fully separated or disjointed from the trailing product or wipe outside the dispenser. In such a fallback situation, the following product or wipe would need to be re-threaded through the dispensing opening when its dispensing is next wanted. As yet another example, if maintaining a maximum moisture level for the wipes is desirable, then having only a select portion of the leading wipe protrude from the dispensing opening aids in more and longer moisture retention, while also enabling continuous dispensing without wipe fallback. The purposes and features of the present invention will be set forth in and are apparent from the description that follows, as well as will be learned by practice of the invention. Additional features of the invention will be realized and attained by the process particularly pointed out in the written description and claims hereof, as well as from the appended drawings.

In one aspect, the invention provides a method for storing and dispensing wet wipes. The method comprises providing a dispenser and a plurality of releasably connected wet wipes, the dispenser comprising a sealable chamber and the chamber configured to loosely retain the plurality of releasably connected wet wipes therein such that the plurality of releasably connected wet wipes can move axially, laterally and longitudinally relative to an inside perimeter of the sealable chamber. The method further comprises positioning a leading wet wipe of the plurality of releasably connected wet wipes in a dispensing opening in communication with the chamber, the opening adapted to dispense wet wipes from the plurality of releasably connected wet wipes through the opening and out of the dispenser. The method can further comprise positioning the dispenser in a vertical orientation opposite a vertical surface such that the dispensing opening faces away from the vertical surface. Still further the method comprises dispensing the plurality of releasably connected wet wipes in a direction away from the dispensing opening and the vertical surface. Finally, the method comprises manually separating the leading wet wipe from an immediately trailing wet wipe by grasping a portion of the leading wet wipe with one hand while also grasping a portion of the immediately trailing wet wipe with a different hand and then separating the hands from each other and consequently separating the leading wet wipe from the trailing wet wipe and while also maintaining a portion of each of the leading wet wipe and the trailing wet wipe in the dispensing opening.

In another aspect, the invention provides a method for storing and dispensing wet wipes. The method comprises providing a dispenser and a plurality of releasably connected wet wipes, the dispenser comprising a sealable chamber and the chamber configured to loosely retain the plurality of releasably connected wet wipes therein such that the plurality of releasably connected wet wipes can move axially, laterally and longitudinally relative to an inside perimeter of the sealable chamber. The method also comprises positioning a leading wet wipe of the plurality of releasably connected wet wipes in a dispensing opening in communication with the chamber, the opening adapted to dispense wet wipes from the plurality of releasably connected wet wipes through the opening and out of the dispenser. The method can also comprise positioning the dispenser in a vertical orientation opposite a vertical surface such that the dispensing opening faces away from the vertical surface. The method further comprises dispensing the plurality of releasably connected wet wipes in a direction away from the dispensing opening and the vertical surface. The method comprises manually separating the leading wet wipe from an immediately trailing wet wipe and maintaining a portion of each of the leading wet wipe and the trailing wet wipe in the dispensing opening. And, the method can comprise leaving a tab of the immediately trailing wet wipe in the dispensing opening after separating is complete and the leading wet wipe is clear of the dispensing opening and wherein the tab has a width that is less than a width of a body of the wet wipe.

In still another aspect, the invention provides a method for storing and dispensing wet wipes. The method comprises providing a dispenser and a plurality of releasably connected wet wipes, the dispenser comprising a sealable chamber and the chamber configured to loosely retain the plurality of releasably connected wet wipes therein such that the plurality of releasably connected wet wipes can move axially, laterally and longitudinally relative to an inside perimeter of the sealable chamber. The method further comprises positioning a leading wet wipe of the plurality of releasably connected wet wipes in a dispensing opening in communication with the chamber, the opening adapted to dispense wet wipes from the plurality of releasably connected wet wipes through the opening and out of the dispenser. The method also comprises dispensing the plurality of releasably connected wet wipes in a direction away from the dispensing opening. The method further comprises manually separating the leading wet wipe from an immediately trailing wet wipe by grasping a portion of the leading wet wipe with one hand while also grasping a portion of the immediately trailing wet wipe with a different hand and then separating the hands from each other and consequently separating the leading wet wipe from the trailing wet wipe and while also maintaining a portion of each of the leading wet wipe and the trailing wet wipe in the dispensing opening. And, the method can also comprise providing the plurality of releasably connected wet wipes connected to each other along a non-linear weakened line such that a leading portion of the trailing wet wipe protrudes through the dispensing opening before the step of manually separating the leading wet wipe from the trailing wet wipe begins.

In yet another aspect, the invention concerns a method for storing and dispensing product. The method comprises providing a dispenser and a plurality of releasably connected product, the dispenser comprising a sealable chamber and the chamber configured to loosely retain the plurality of releasably connected product therein such that the plurality of releasably connected product can move axially, laterally and longitudinally relative to an inside perimeter of the sealable chamber. The invention also comprises positioning a leading product of the plurality of releasably connected product in a dispensing opening in communication with the chamber, the opening adapted to dispense product from the plurality of releasably connected product through the opening and out of the dispenser. The invention further comprises dispensing the plurality of releasably connected product in a direction away from the dispensing opening. Also, the invention comprises manually separating the leading product from an immediately trailing product by grasping a portion of the leading product with one hand while also grasping a portion of the immediately trailing product with a different hand and then separating the hands from each other and consequently separating the leading product from the trailing product and while also maintaining a portion of each of the leading product and the trailing product in the dispensing opening. Further, the invention comprises providing the plurality of releasably connected product connected to each other along a non-linear weakened line such that a leading portion of the trailing product protrudes through the dispensing opening before the step of manually separating the leading product from the trailing product begins.

In yet other aspects, the invention provides various configurations for the wet wipes, the dispenser, and the relationships of these to each other.

Definitions

As used herein, wet wipes or product of the invention are considered “releasably connected” (and variations thereof) when each product or wipe of a plurality, e.g., in a roll or stack of wipes, is engaging any adjacent product or wipe while in the dispenser or package such that withdrawing the leading product or wipe through the dispensing or package opening also withdraws at least a portion of the following product or wipe through the opening before the leading product or wipe and the following product or wipe separated completely from each other. Such engaging of any adjacent product or wipe can include an interfolded relationship or a non-interfolded relationship in combination with one or more of the following between adjacent product or wipes: adhesive, friction, cohesion, fusion bonding (e.g., ultrasonic welding, heat sealing), mechanical entanglement (e.g., needle punching, steam sealing, embossing, crimping), autogeneous bonding, and/or weakened line(s) (e.g., perforations, zones of frangibility, score line(s), crush cutting).

As used herein, the term “wet wipe” refers to a fibrous sheet that has a liquid applied thereto during manufacture. The amount of liquid or solution contained within each wet wipe can vary depending upon the type of material being used to provide the wet wipe, the type of liquid being used, the type of container being used to store the wet wipes, and the desired end use of the wet wipe. Generally, each wet wipe can contain from about 25 to about 700 weight percent or from about 200 to about 400 weight percent liquid based on the dry weight of the wipe, for improved wiping in certain situations. To determine the liquid add-on, first the weight of a just-manufactured dry wipe is determined. Then, the amount of liquid by weight equal to the weight of the just-manufactured dry wipe, or an increased amount of liquid measured as a percent add-on based on the weight of the just-manufactured dry wipe, is added to the wipe to make it moistened, and then known as a “wet wipe” or “wet wipes”. The liquid may include a fragrance and/or an emollient and may serve to aid the fibrous sheet in retention of materials, which are to be wiped up during its utilization.

As used herein, the term “non-linear” refers to the configuration of a weakened portion, e.g., perforations, of the wet wipes across a width W₁ (FIG. 1B) of the web of material forming the wet wipes, such that the configuration is not a single straight line extending from one edge of the sheet across to a corresponding adjacent edge of the sheet (e.g., FIGS. 1-3, inclusive). Rather, the configuration can have straight lines, curved lines or both types of line segments joined together from one edge to the other edge, but at least two of these line segments adjoined across the sheet will not be parallel to each other.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention.

### DRAWINGS

The drawings are merely representative and are not intended to limit the scope of the claims. Like parts depicted in the drawings are referred to by the same reference numerals.

FIG. 1A representatively shows a top view of a portion of two releasably connected wet wipes as they might be positioned in a dispensing opening before separation of the leading wet wipe from the trailing wet wipe, in accordance with the invention.

FIG. 1B representatively shows a top view of the wet wipes in FIG. 1A, but now as they might be positioned in the dispensing opening during separation of the leading wet wipe from the trailing wet wipe.

FIG. 2A is similar to FIG. 1A, but with an alternate weakened line configuration.

FIG. 2B is related to FIG. 2A, and similar to FIG. 1B but with an alternate weakened line configuration.

FIG. 3A is similar to FIG. 1A, but with an alternate weakened line configuration.

FIG. 3B is related to FIG. 3A, and similar to FIG. 1B but with an alternate weakened line configuration.

FIG. 4 is a front view of a dispenser for storing and dispensing wet wipes in accordance with the invention.

FIG. 5 is a side view of the dispenser of FIG. 4.

FIG. 6 is a perspective exploded view of the dispenser of FIG. 4.

FIG. 7 is a perspective view of a convention bath tissue holder with a mounting mechanism for the dispenser mounted therein.

FIG. 8 is a perspective view of a plurality of releasably connected wet wipes, in roll form.

FIG. 9 is a cross-sectional view of a portion of the dispenser in FIG. 4, taken along the line 9-9, and with a plurality of releasably connected wet wipes, in roll form, placed therein.

FIG. 10 is a cross-sectional view of a cartridge and plurality of releasably connected wet wipes, in roll form, which can be placed in the dispenser as a unit.

FIG. 11 is a perspective exploded view of an alternate dispenser for storing and dispensing wipes, in accordance with the invention.

FIG. 12 is a perspective view of yet another dispenser for storing and dispensing wipes in accordance with the invention, the dispenser hanging from a conventional bath tissue holder.

FIG. 13 is a perspective view of the dispenser in FIG. 12, but now in an open position and without any wet wipes therein.

FIG. 14 is a front view of yet another dispenser for storing and dispensing wet wipes in accordance with the invention, resting on a horizontal support surface.

FIG. 15 is a perspective side view of the dispenser of FIG. 14, the dispenser inverted 180 degrees so the dispensing opening faces upward and with a portion of a wet wipe protruding therefrom.

FIG. 16 is a cross-sectional view of the dispenser in FIG. 14, taken along the line 16-16.

FIG. 17 is an enlarged view of the portion of the dispenser in FIG. 16 that is labeled A.

FIG. 18 is an enlarged alternate view of a portion of the dispenser like that in FIG. 16 that is labeled A, but now with a portion of a wet wipe protruding through the dispensing opening.

### DETAILED DESCRIPTION

As a result of their work, the inventors has determined that particular configurations and characteristics for storing and dispensing product or wet wipes are better than others for overcoming some challenges to making the dispensing of product or wet wipes in a continuous dispensing format more convenient and desirable. Such can be beneficial to, e.g., more accurate product or wipe retrieval and/or reducing the amount of wet wipe dry out over time and/or reducing the likelihood or amount of contamination of the product or wipe. That is, the inventors believe they have discovered new, surprising and unexpected ways to store and dispense product or wet wipes unlike ever before taught. This is particularly advantageous and challenging in a continuous dispensing format because of the need to balance the opposite concerns of product or wipe fallback (i.e., which suggests having a significant portion of the trailing wipe protrude though the dispensing opening between dispensing occasions) versus product or wipe dry out or contamination(i.e., which suggests having little to no portion of the trailing wipe protrude though the dispensing opening between dispensing occasions).

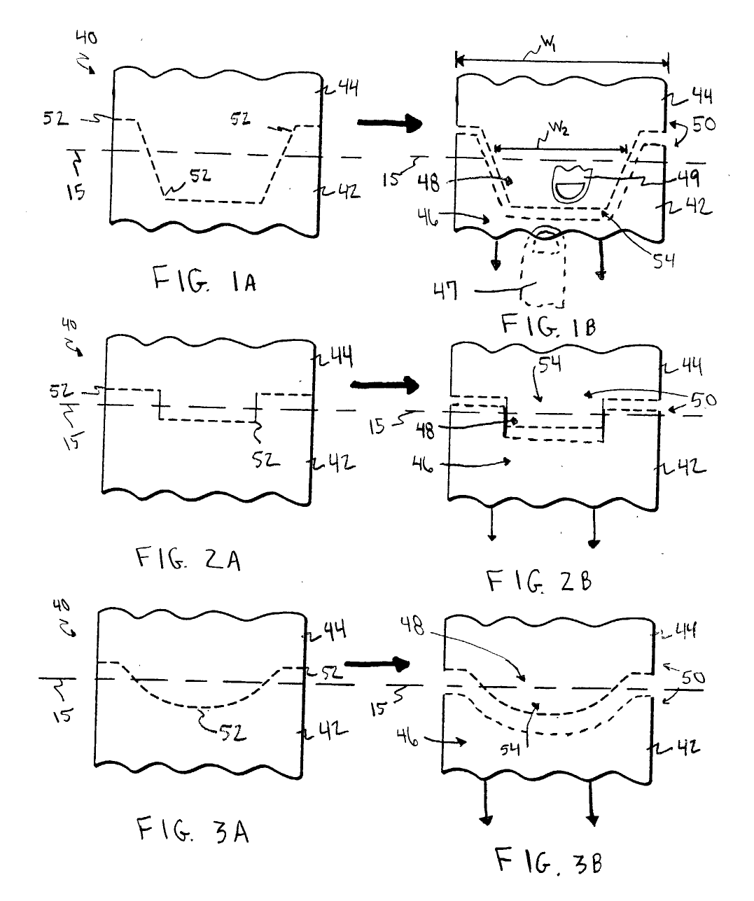

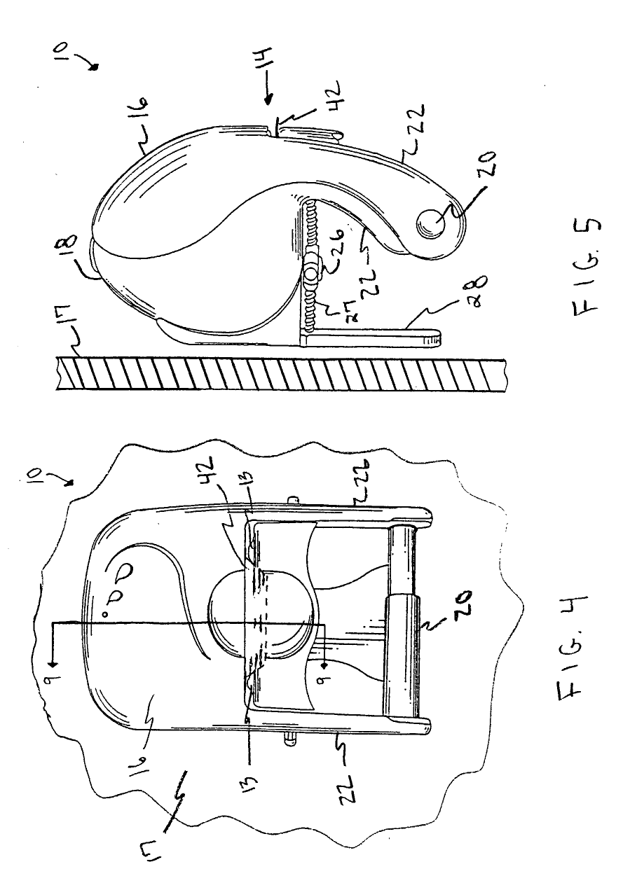

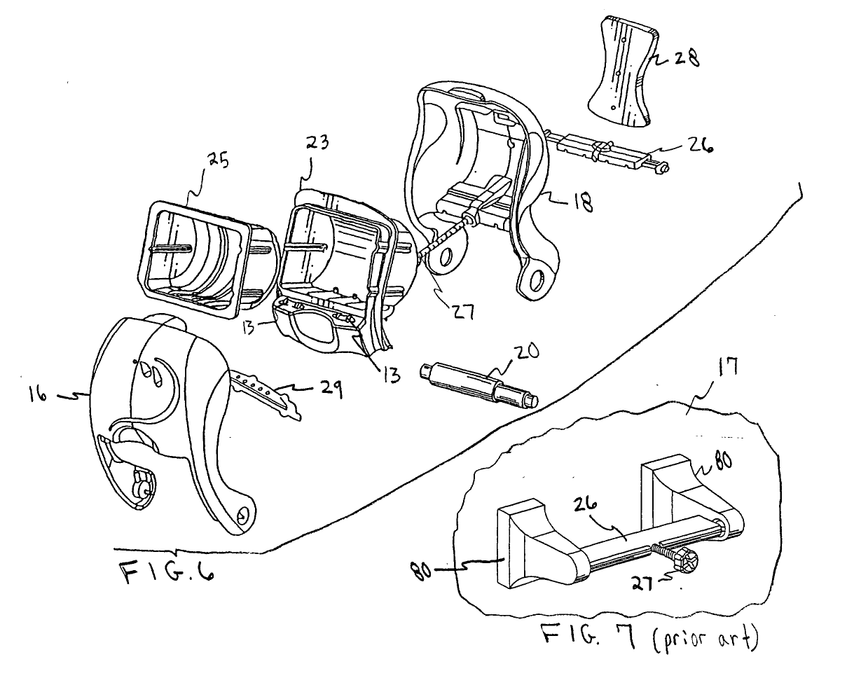

Referring to the Figures, there are seen representative configurations for wet wipes and dispensers of the invention. Similar configurations could be used for product of the invention, but for representative purposes only the following discussion will be in reference to wet wipes. FIGS. 1A, 2A and 3A show three representative configurations for a non-linear weakened line 52, e.g., of perforations, between adjoining wet wipes 42, 44 in a plurality of releasably connected wet wipes 40, such as in roll form 60 (FIG. 8), before the adjoining wipes are separate from each other. FIGS. 1B, 2B and 3B are similar to their 1A, 2A, 3A counterparts, but now showing the adjacent wipes in various stages of separation relative to a dispensing opening represented by broken line 15. Also, FIG. 1B shows the representative placement of a users hands 47, 49, e.g., thumbs, for manually separating the leading wet wipe 42 from the immediately trailing wet wipe 44. For example, this can be done by grasping a portion 46 of the leading wet wipe with one hand 47 while also grasping a portion 48 of the immediately trailing wet wipe with a different hand 49 and then separating the hands 47, 49 from each other and consequently separating the leading wet wipe 42 from the trailing wet wipe 44. As such, this can also include maintaining a portion 50 of each of the leading wet wipe and the trailing wet wipe in the dispensing opening, even if only for at least a brief instant before complete separation of the adjacent wet wipes. Additionally, or alternatively, and discussed further below, it can be advantageous where the non-linear weakened line 52 forms a tab 54 for the trailing wet wipe (i.e., and which then becomes the leading wet wipe), to enhance reliable and desired dispensing as first discussed. More particularly, this can include the tab 54 having a width W₂ that is less than a width W₁ of a body of the wet wipe.

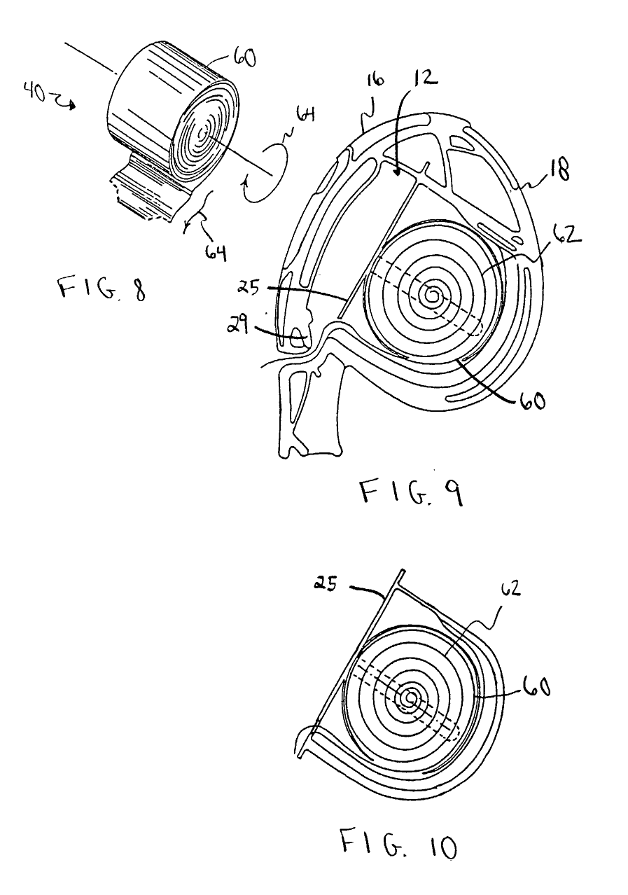

FIGS. 4-10 depict a representative dispenser 10 of the invention, where additional teaching of this dispenser can be found in previously mentioned Ser. No. 09/659,307 filed Sep. 12, 2000 and entitled “Mounting System For A Wet Wipes Dispenser.” Dispenser 10 has a sealable chamber 12 in communication with a dispensing opening 14. Chamber 12 is formed between a cover 16 and a housing 18. The chamber is configured to loosely retain the plurality of releasably connected wet wipes 40 therein such that the plurality of releasably connected wet wipes can move axially, laterally and longitudinally relative to an inside perimeter of the sealable chamber. That is, such a chamber configuration allows the plurality of wipes to be at least somewhat free to move in these directions and not be completely restrained against movement in these directions during the normal course of the dispensing of wet wipes.

The housing and the cover may be separate, separable components; they may be integral; or they may be fixed together or removably mounted together. For example, the cover can be hingedly attached to the housing so that the front cover can swing open for placing wipes in the dispenser and then swing shut. The cover and the housing form the dispensing opening, through which a wet wipe can extend for dispensing. The dispenser 10 may also have arms 22 that extend from the dispenser to hold a spindle or roller 20 for supporting a roll of another product, such as dry or conventional bath tissue, or for hanging the dispenser 10 from such a conventional spindle 20.

Referring to FIGS. 4-6 and 9, the cover 16 is designed to form a barrier to moisture loss from the wet wipes. This barrier may be formed due to cooperation with other components of the dispenser, such as the housing 18, a cartridge 25 or tray 23 for holding the plurality of wet wipes. The cover 16 may further be designed to cooperate with the cartridge 25, the housing 18, the tray 23, or other components of the dispenser, to form a barrier to contamination of the wipes within the dispenser. Thus, the cover in cooperation with the cartridge, or other components of the dispenser, may form a barrier to dirt, dust, mold spores and bacteria, while also retaining moisture within the sealable chamber 12.

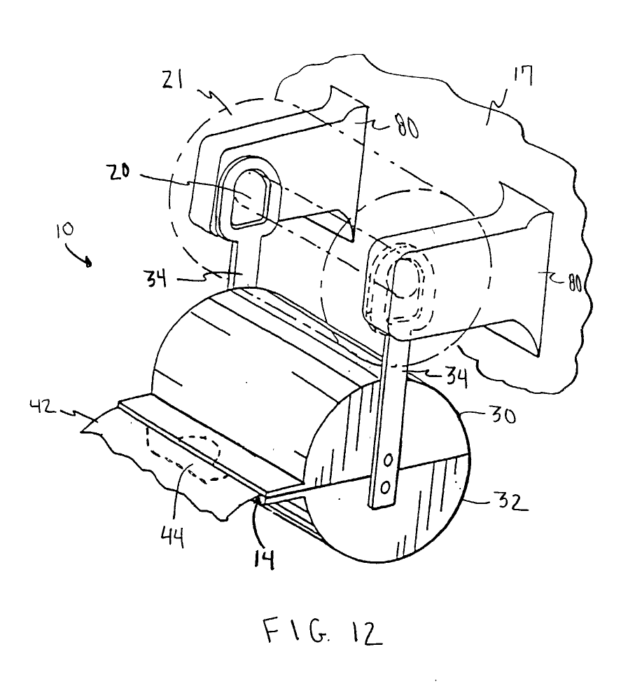

Dispenser 10 can also include a partial restriction in the dispensing opening. Such a partial restriction acts to impart some force upon the wet wipes that is resistive to the dispensing direction 64 (FIG. 8) but does not completely stop dispensing of the wet wipes. Advantageously, this resistive force can be implemented to provide enough force to enable desired sealing functions for the sealable chamber but not so much as to cause the releasably connected wipes to separate until a user desires to do so by engaging their hands on opposite sides of a weakened line and then separating their hands and the grasped wipes. As an alternative, advantageously, this resistive force can be implemented to provide enough shear to enable desired sealing functions for the sealable chamber and enough shear force to cause the releasably connected wipes to separate at the weakened line without a user having to engage their hands on opposite sides of a weakened line and then separate their hands and the grasped wipes. The partial restriction in the dispensing opening could be any of a variety of mechanisms, such as, for example, a wiper blade 29 (FIGS. 6 and 9), a stepped path 19 (FIGS. 17 and 18), a path sized slightly smaller than the thickness of a wipe, a path sized slightly more narrow than the width W₁ of a wipe (FIG. 1B), a roller or group of rollers 24 (FIG. 11), a zigzag path relative to the thickness or width of the wipes, a combination of any of these, and similar type mechanisms that achieve the same desired function for such a partial restriction.

As seen in FIGS. 4-6 and 9, a wiper blade 29 could be attached to the cover 16 and the blade designed to function with guides 13 and the tray 23 and to some extent the lip of the cartridge 25. Depending on the placement of the wiper blade, it could have greater or lesser interaction with these components of the dispenser. The gap between the end of the wiper blade and the tray may be varied depending upon the thickness of the wet wipes and how much drag or shear force is need for the dispenser to function as desired. The wiper blade can also assist to hold the edge of the leading wet wipe 42 in place and thus better keep the edge from falling back through the dispensing opening and into the sealable chamber between dispensings. If the wipes are made such that they are dry in storage and become wet during use, the blade may be configured to exert pressure on the wipe. In this case, the dispensing of a sheet or sheets causes sufficient shear to be applied to the wipe to permit the moisture to be released. For example, this force or shear may be sufficient to cause microcapsules of fluid to burst or may be sufficient to rupture a protective emulsion which contains the fluid.

Wiper blades can be made out of any flexible material, such as thermoplastic elastomers, foam, sponge, plastic, or rubber having a shore A durometer hardness value ranging about 0 to 80, from about 15 to about 70 and from about 30 to about 60. It is further desirable that the wiper blades be made from a material that will form a good moisture and contamination barrier. Examples of desirable types of material are SANTOPRENE®, KRATON®, silicone, or styrene-ethylene/butylene-styrene (SEBS). The force applied to the wipe by the wiper blade when pulling the wipe from the dispenser should not be greater than the tensile strength of the wipe body that is not weakened, e.g., perforated, and not greater than the tensile strength of wipe at the weakened portion, e.g., perforation.

FIG. 11 depicts an alternative representative dispenser 10 of the invention, where additional teaching of this dispenser can be found in previously mentioned Ser. No. 09/545,995 filed Apr. 10, 2000 and entitled “Dispenser For Premoistened Wipes.” This dispenser 10 has a sealable chamber 12 in communication with a dispensing opening 14. Chamber 12 is formed between a cover 16 and a housing 18. The chamber is configured to loosely retain the plurality of releasably connected wet wipes 40 therein such that the plurality of releasably connected wet wipes can move axially, laterally and longitudinally relative to an inside perimeter of the sealable chamber. In other respects this dispenser is similar to that in FIG. 4, but instead of a wiper blade there is a group of cooperating rollers 24, which are mounted in the cover 16 and the tray 23. The cover, tray, housing, and mounting mechanism have different configurations than the corresponding parts in the dispenser in FIG. 4, but the operative aspects as concerns the present invention function generally similar.

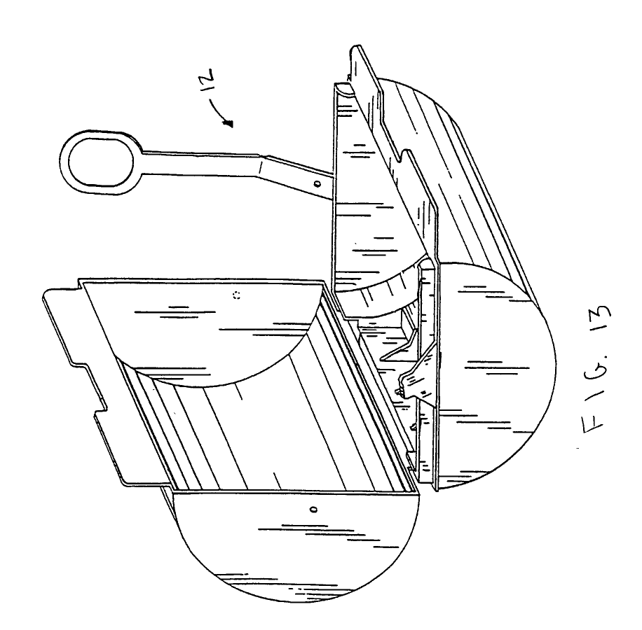

FIGS. 12 and 13 depict yet an alternative representative dispenser 10 of the invention, where additional teaching of this dispenser can be found in previously mentioned U.S. Pat. No. 5,897,074 issued Apr. 27, 1999 and entitled “Moist Tissue Dispenser Having Sealing Arms.” This dispenser may be configured such that the plurality of releasably connected wet wipes are dispensed from an area below a conventional bath tissue holder 80. Here, the dispenser 10 has a clam shell like configuration, where a sealable chamber 12 is in communication with a dispensing opening 14. Chamber 12 is formed between an upper clam shell 30 and a lower clam shell 32. The chamber is configured to loosely retain the plurality of releasably connected wet wipes therein such that the plurality of releasably connected wet wipes can move axially, laterally and longitudinally relative to an inside perimeter of the sealable chamber. The upper and lower shells may be removably or hingedly attached to each other, such as at the back of the dispenser. In this way, the upper clam shell can be removed or pivoted, and the wet wipes can be placed in the dispenser.

A pair of hangers or sealing arms 34 may extend from either or both shells 30, 32 and engage the conventional roller 20, allowing the dispenser to be mounted below the conventional holder 80: In this way, a conventional bath tissue roll 21 can also be provided above the dispenser 10. The dispenser may also have a tray or cartridge like the previous dispensers, though not shown as such here. The wet wipes can be placed in this tray or cartridge, or directly into the lower shell, and then dispensed from within the sealable chamber 12. This dispenser does not employ a partial restriction, though it could based on the teachings here. Alternatively, or additionally, when the arms 34 are not employed, this dispenser may be placed such that the plurality of releasably connected wet wipes are dispensed from a horizontal surface upon which the dispenser rests, or while the dispenser is being held by a user.

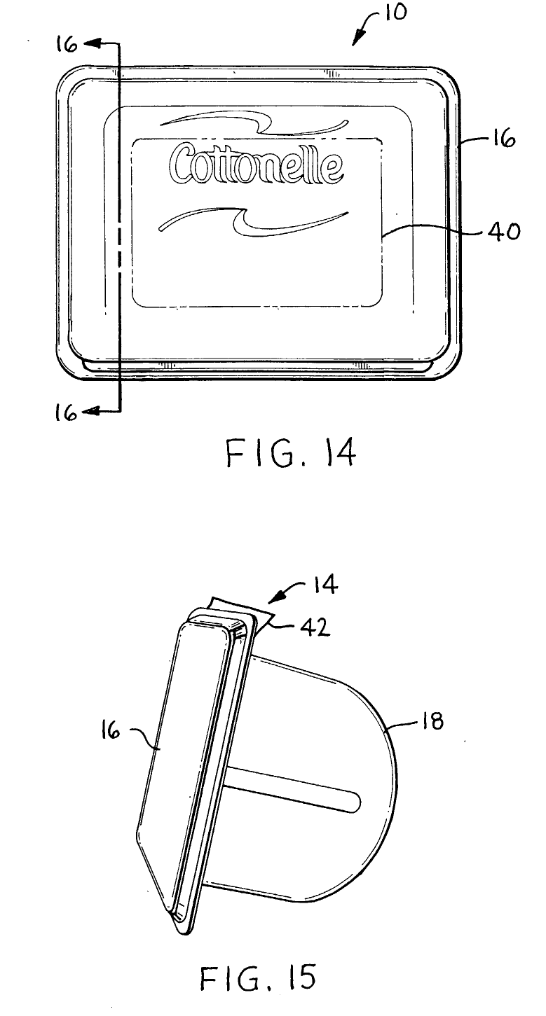

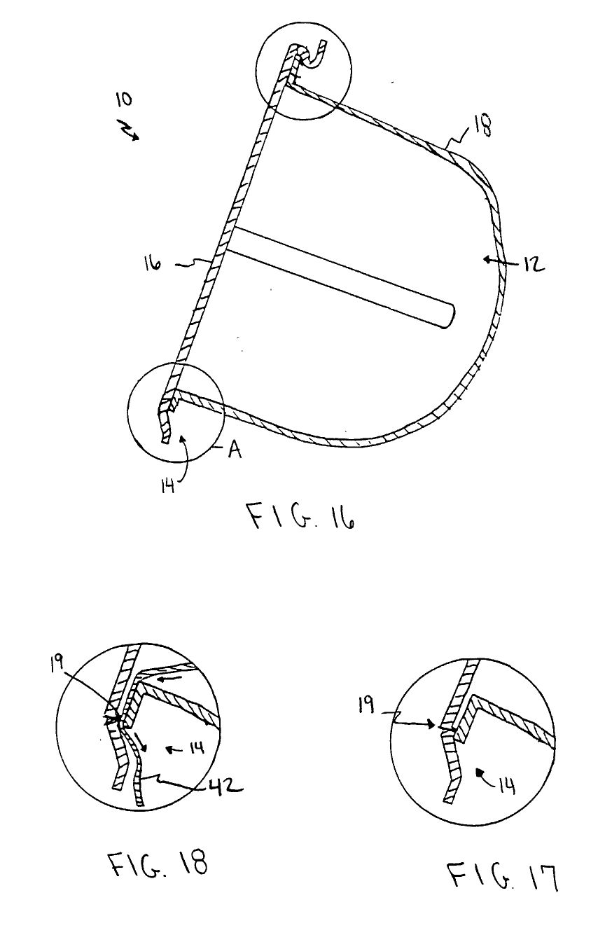

FIGS. 14-18 depict still another alternative representative dispenser 10 of the invention, where additional teaching of this dispenser can be found in previously mentioned Ser. No. 10/016,952 filed Dec. 14, 2001 and entitled “Cartridge Dispensing System And Method.” This dispenser may be configured such that the plurality of releasably connected wet wipes are dispensed from a horizontal surface upon which the dispenser rests, or while the dispenser is being held by a user. Here, the dispenser 10 has a sealable chamber 12 in communication with a dispensing opening 14. Chamber 12 is formed between a cover 16 and a housing 18. The chamber is configured to loosely retain the plurality of releasably connected wet wipes 40 therein such that the plurality of releasably connected wet wipes can move axially, laterally and longitudinally relative to an inside perimeter of the sealable chamber. This dispenser has a stepped path 19 acting as a partial restriction. The wet wipes can be placed directly into the housing and then dispensed from within the sealable chamber 12.

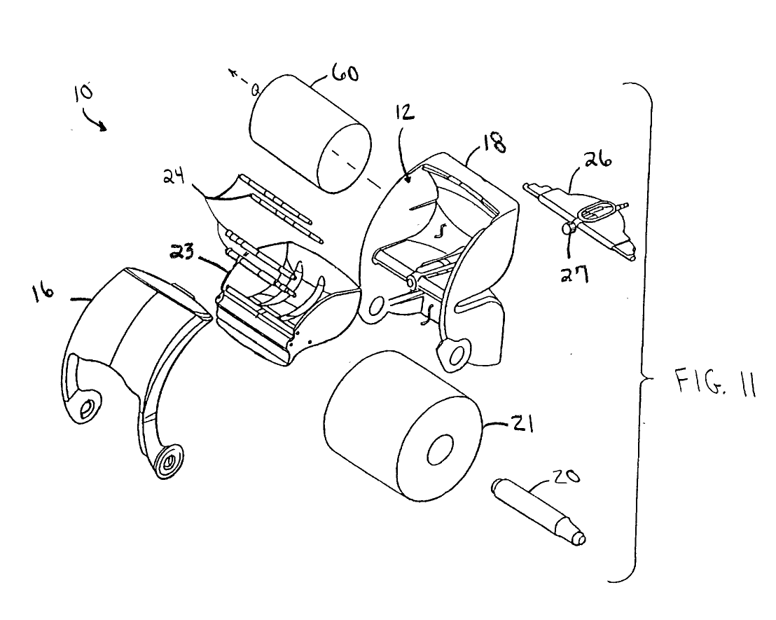

Dispenser 10 can be positioned in a vertical orientation (e.g., FIGS. 4, 5, 10, 12) opposite a vertical surface 17 (e.g., a wall, a toilet tank, a cabinet, or the like) such that the dispensing opening 14 faces away from the vertical surface. In this way, dispensing of the plurality of releasably connected wet wipes can be in a direction away from the dispensing opening and the vertical surface. Such can be accomplished by use of any mechanical type fastener (e.g., adhesive, screw, bolt, nail, rivet, hook and loop fastening system, or the like) connected directly with the housing 18 and the vertical surface 17, as in the case of the dispenser embodiments in FIGS. 4 and 11, or indirectly using a mounting plate with the mechanical fastener, as in the case of the dispenser embodiment in FIG. 4. Alternatively, such can be accomplished by use of a mounting mechanism 26 connected directly with the housing 18 and to a conventional bath tissue holder 80 (FIG. 7), as in the case of the dispenser embodiments in FIGS. 4 and 11 though they are not shown so mounted but could be. Still alternatively, as in the case of the dispenser embodiment in FIG. 12, such can be accomplished by use of hangers or arm supports 34 connected directly with the upper or lower clam shell 30, 32 and by which supports 34 are attachable with a conventional bath tissue spindle or roller 20 which is in turn attachable with a conventional bath tissue holder 80. Differently, the dispenser 10 could be positioned in a non-vertical orientation such that dispensing of the plurality of releasably connected wet wipes can be in a direction away from the dispensing opening, and/or a horizontal surface, as in the case of the dispenser in FIGS. 14-15. In this way the dispenser can rest on a surface without regard to that of the vertical surface 17, and rather, advantageously in a horizontal orientation relative to a horizontal surface.

FIGS. 8-10 show the roll 60 as it is placed in the cartridge 25 and in the dispenser 10. The spiral line 62 is intended to represent the manner in which the roll is wound and depicts in that configuration a roll that is being unwound from the bottom in direction 64, as one of two possible configurations. FIG. 9 further shows the relationship of the wiper blade 29 to the wet wipes. FIG. 10 shows the roll 60 in cartridge 25, with spiral line 62 indicating the wind of the roll. Although FIGS. 8-10 specifically show one type of dispenser for use with the invention, the same teaching can apply to the other dispensers disclosed here, as well as other similarly functioning dispensers.

Wet wipes useful with dispensers for practicing the invention could be made from any conventionally available materials, e.g., previously mentioned Ser. No. 09/900,698 filed Jul. 6, 2001 entitled “Pre-Moistened Wipe Product,” and others mentioned previously. Such wet wipes could be in roll form as in FIG. 8, e.g., and as described in previously mentioned Ser. No. 09/660,040 filed Sep. 12, 2000 and entitled “Roll of Wet Wipes”, or in a stack form and as described in previously mentioned Ser. No. 09/871,019 filed May 31, 2001 entitled “Stack Of Fan Folded Material And Combinations Thereof; provided such rolls would be made to have a non-linear weakened lined configuration, e.g., those set forth herein or the like. Such plurality of releasably connected wet wipes may contain from as little as a few linear inches (or cm) to more than 450 linear inches (11.43 m), to more than linear 600 inches (15.24 m) to more than a thousand linear inches (25.40 m) of wet wipes. The plurality may have a web of material that may have any number of sheets. The sheets are separated by non-linear weakened lines, e.g., perforations, that enable the sheet to be easily torn from the web but are strong enough that they will not separate while the web is being pulled from the dispenser through the dispensing opening until separation is desired by the user. An example of rolls that could be particularly useful for the invention are those found in either commercially available product such as currently available KLEENEX® brand COTTONELLE® FRESH™ Pre-Moistened & Flushable Rollwipes from Kimberly-Clark Corporation of Neenah, Wis. or CHARMIN® brand FRESH MATES™ Pre-Moistened Wipes on a Roll from Proctor & Gamble of Cincinnati, Ohio, or the like; provided such rolls would be made to have a non-linear weakened lined configuration, e.g., those set forth herein or the like. A desirable form of wet wipes for use with the dispenser system is a solid coreless roll as shown in FIGS. 8-10. It is to be understood, however, that cored rolls (hollow cores, solid cores and partially solid cores), hollow coreless rolls, and stacks of sheets may also be used for in the method of the invention for storing and dispensing wet wipes.

In conjunction with the previous discussion, practicing the method for storing and dispensing wet wipes in accordance with the invention involves various combinations of the following steps. The steps may be, advantageously, performed in the following order, but often times need not be. First, a user provides a dispenser 10 and a plurality of releasably connected wet wipes 40. The dispenser has a sealable chamber 12 and the chamber is configured to loosely retain the plurality of releasably connected wet wipes therein such that the plurality of releasably connected wet wipes can move axially, laterally and longitudinally relative to an inside perimeter of the sealable chamber. Alternatively, or additionally, the user may position the dispenser in a vertical orientation opposite a vertical surface 17 such that the dispensing opening 14 faces away from the vertical surface. Next, the user positions a leading wet wipe 42 of the plurality of releasably connected wet wipes 40 in the dispensing opening 14 in communication with the chamber 12, e.g., by placing the wet wipes 40 in the chamber 12 and threading or otherwise positioning the leading wet wipe 42 in the opening 14. The opening is adapted to dispense wet wipes from the plurality of releasably connected wet wipes through the opening 14 and out of the dispenser 10. Then, the user dispenses the plurality of releasably connected wet wipes in a direction away from the dispensing opening 14, and also optionally, away from the vertical surface 17.

Next, the user manually separates the leading wet wipe 42 from an immediately trailing wet wipe 44. For example, this can be accomplished by the user grasping a portion 46 of the leading wet wipe with one hand 47 while also grasping a portion 48 of the immediately trailing wet wipe with a different hand 49. In this way, then, the user separates the hands 47, 49 from each other and consequently separates the leading wet wipe 42 from the trailing wet wipe 44, and also maintains a portion of each of the leading wet wipe and the trailing wet wipe in the dispensing opening, e.g., even if only for a brief instant before the adjacent wipes completely separate. Alternatively, or additionally, this can be accomplished by maintaining a portion 50 of each of the leading wet wipe and the trailing wet wipe in the dispensing opening , e.g., even if only for a brief instant before the adjacent wipes completely separate, and leaving a tab 54 of the immediately trailing wet wipe in the dispensing opening after separating is complete and the leading wet wipe is clear of the dispensing opening. By this accomplishment, it can also be advantageous where the tab has a width W₂ that is less than a width W₁ of a body of the wet wipe. Alternatively, or additionally, this can be accomplished in conjunction with the wet wipes connected to each other along a non-linear weakened line 52 such that a leading portion 48 of the trailing wet wipe protrudes through the dispensing opening before the step of manually separating the leading wet wipe from the trailing wet wipe begins. By each of the preceding accomplishments, one or more developments of the invention can be practiced (e.g., reducing wet wipe dry out and/or reducing the likelihood of wipe fallback).

Further, the steps of the invention can include some or all of the following: maintaining the portion 50 of each of the leading wet wipe and the trailing wet wipe in the dispensing opening even after complete separation of the leading wet wipe from the trailing wet wipe (i.e., even if only for a brief instant before completely removing the leading wet wipe from the opening); dispensing the plurality of releasably connected wet wipes past a partial restriction, e.g., a wiper blade 29, a stepped path 19, or the like, in the dispensing opening; mounting the dispenser in a conventional bath tissue holder 80; hanging the dispenser below the conventional bath tissue holder 80; or, providing the plurality of releasably connected wet wipes in a roll form 60.

All publications, patents, and patent documents cited in the specification are incorporated by reference herein, as though individually incorporated by reference. In the case of any inconsistencies, the present disclosure, including any definitions herein, will prevail. While the invention has been described in detail with respect to the specific aspects thereof, it will be appreciated that those skilled in the art, upon attaining an understanding of the foregoing, may readily conceive of alterations to, variations of, and equivalents to these aspects which fall within the spirit and scope of the present invention, which should be assessed accordingly to that of the appended claims.

What is claimed is:

1. A method for storing and dispensing wet wipes, comprising:
providing a dispenser and a plurality of releasably connected wet wipes, the dispenser comprising a sealable chamber and the chamber configured to loosely retain the plurality of releasably connected wet wipes therein such that the plurality of releasably connected wet wipes can move axially, laterally and longitudinally relative to an inside perimeter of the sealable chamber;
positioning a leading wet wipe of the plurality of releasably connected wet wipes in a dispensing opening in communication with the chamber, the opening adapted to dispense wet wipes from the plurality of releasably connected wet wipes through the opening and out of the dispenser;
positioning the dispenser in a vertical orientation opposite a vertical surface such that the dispensing opening faces away from the vertical surface;
dispensing the plurality of releasably connected wet wipes in a direction away from the dispensing opening and the vertical surface; and
manually separating the leading wet wipe from an immediately trailing wet wipe by grasping a portion of the leading wet wipe with one hand while also grasping a portion of the immediately trailing wet wipe with a different hand and then separating the hands from each other and consequently separating the leading wet wipe from the trailing wet wipe and while also maintaining a portion of each of the leading wet wipe and the trailing wet wipe in the dispensing opening.

2. The method of claim 1 wherein maintaining the portion of each of the leading wet wipe and the trailing wet wipe in the dispensing opening further includes doing so even after complete separation of the leading wet wipe from the trailing wet wipe.

3. The method of claim 1 further comprising providing the plurality of releasably connected wet wipes connected to each other along a non-linear weakened line such that a leading portion of the trailing wet wipe protrudes through the dispensing opening before the step of manually separating the leading wet wipe from the trailing wet wipe begins.

4. The method of claim 1 further comprising leaving a tab of the immediately trailing wet wipe in the dispensing opening after separating is complete and the leading wet wipe is clear of the dispensing opening and wherein the tab has a width that is less than a width of a body of the wet wipe.

5. The method of claim 1 further comprising dispensing the plurality of releasably connected wet wipes past a partial restriction in the dispensing opening.

6. The method of claim 1 wherein positioning the dispenser in the vertical orientation comprises mounting the dispenser in a conventional bath tissue holder.

7. The method of claim 6 wherein mounting further comprises hanging the dispenser below the conventional bath tissue holder.

8. The method of claim 1 wherein providing comprises providing the plurality of releasably connected wet wipes in a roll form.

9. A method for storing and dispensing wet wipes, comprising:
providing a dispenser and a plurality of releasably connected wet wipes, the dispenser comprising a sealable chamber and the chamber configured to loosely retain the plurality of releasably connected wet wipes therein such that the plurality of releasably connected wet wipes can move axially, laterally and longitudinally relative to an inside perimeter of the sealable chamber;
positioning a leading wet wipe of the plurality of releasably connected wet wipes in a dispensing opening in communication with the chamber, the opening adapted to dispense wet wipes from the plurality of releasably connected wet wipes through the opening and out of the dispenser;
positioning the dispenser in a vertical orientation opposite a vertical surface such that the dispensing opening faces away from the vertical surface;
dispensing the plurality of releasably connected wet wipes in a direction away from the dispensing opening and the vertical surface;
manually separating the leading wet wipe from an immediately trailing wet wipe and maintaining a portion of each of the leading wet wipe and the trailing wet wipe in the dispensing opening; and
leaving a tab of the immediately trailing wet wipe in the dispensing opening after separating is complete and the leading wet wipe is clear of the dispensing opening and wherein the tab has a width that is less than a width of a body of the wet wipe.

10. The method of claim 9 wherein maintaining the portion of each of the leading wet wipe and the trailing wet wipe in the dispensing opening further includes doing so even after complete separation of the leading wet wipe from the trailing wet wipe.

11. The method of claim 9 further comprising providing the plurality of releasably connected wet wipes connected to each other along a non-linear weakened line such that a leading portion of the trailing wet wipe protrudes through the dispensing opening before the step of manually separating the leading wet wipe from the trailing wet wipe begins.

12. The method of claim 9 further comprising dispensing the plurality of releasably connected wet wipes past a partial restriction in the dispensing opening.

13. The method of claim 9 wherein positioning the dispenser in the vertical orientation comprises mounting the dispenser in a conventional bath tissue holder.

14. The method of claim 13 wherein mounting further comprises hanging the dispenser below the conventional bath tissue holder.

15. The method of claim 9 wherein providing comprises providing the plurality of releasably connected wet wipes in a roll form.

16. A method for storing and dispensing wet wipes, comprising:
providing a dispenser and a plurality of releasably connected wet wipes, the dispenser comprising a sealable chamber and the chamber configured to loosely retain the plurality of releasably connected wet wipes therein such that the plurality of releasably connected wet wipes can move axially, laterally and longitudinally relative to an inside perimeter of the sealable chamber;
positioning a leading wet wipe of the plurality of releasably connected wet wipes in a dispensing opening in communication with the chamber, the opening adapted to dispense wet wipes from the plurality of releasably connected wet wipes through the opening and out of the dispenser;
dispensing the plurality of releasably connected wet wipes in a direction away from the dispensing opening;
manually separating the leading wet wipe from an immediately trailing wet wipe by grasping a portion of the leading wet wipe with one hand while also grasping a portion of the immediately trailing wet wipe with a different hand and then separating the hands from each other and consequently separating the leading wet wipe from the trailing wet wipe and while also maintaining a portion of each of the leading wet wipe and the trailing wet wipe in the dispensing opening; and
providing the plurality of releasably connected wet wipes connected to each other along a non-linear weakened line such that a leading portion of the trailing wet wipe protrudes through the dispensing opening before the step of manually separating the leading wet wipe from the trailing wet wipe begins.

17. The method of claim 16 wherein maintaining the portion of each of the leading wet wipe and the trailing wet wipe in the dispensing opening further includes doing so even after complete separation of the leading wet wipe from the trailing wet wipe.

18. The method of claim 16 further comprising leaving a tab of the immediately trailing wet wipe in the dispensing opening after separating is complete and the leading wet wipe is clear of the dispensing opening and wherein the tab has a width that is less than a width of a body of the wet wipe.

19. The method of claim 16 further comprising dispensing the plurality of releasably connected wet wipes past a partial restriction in the dispensing opening.

20. The method of claim 16 wherein providing comprises providing the plurality of releasably connected wet wipes in a roll form.

21. A method for storing and dispensing product, comprising:
providing a dispenser and a plurality of releasably connected product, the dispenser comprising a sealable chamber and the chamber configured to loosely retain the plurality of releasably connected product therein such that the plurality of releasably connected product can move axially, laterally and longitudinally relative to an inside perimeter of the sealable chamber;
positioning a leading product of the plurality of releasably connected product in a dispensing opening in communication with the chamber, the opening adapted to dispense product from the plurality of releasably connected product through the opening and out of the dispenser;
dispensing the plurality of releasably connected product in a direction away from the dispensing opening;
manually separating the leading product from an immediately trailing product by grasping a portion of the leading product with one hand while also grasping a portion of the immediately trailing product with a different hand and then separating the hands from each other and consequently separating the leading product from the trailing product and while also maintaining a portion of each of the leading product and the trailing product in the dispensing opening; and
providing the plurality of releasably connected product connected to each other along a non-linear weakened line such that a leading portion of the trailing product protrudes through the dispensing opening before the step of manually separating the leading product from the trailing product begins.

22. The method of claim 21 wherein the product is a plurality of releasably connected wet wipes.
